(19) United States
(12) Patent Application Publication
(10) Pub. No.: US 2007/0287457 A1
(43) Pub. Date: Dec. 13, 2007

(54) Method for introducing a limited service to a mobile subscriber from a neighboring cell

(75) Inventors: Chun-Feng Yeh, Tainan City (TW); Chun-Chieh Yang, Taipei (TW)

Correspondence Address: LADAS & PARRY, 26 WEST 61ST STREET, NEW YORK, NY, 10023, US

(73) Assignee: BENQ CORPORATION

(21) Appl. No.: 11/811,603

(22) Filed: Jun. 11, 2007

(30) Foreign Application Priority Data
Jun. 13, 2006 (TW) 95121043

(51) Int. Cl. H04Q 7/20

(52) U.S. Cl. 455/435.1

(57) ABSTRACT

A method for introducing a limited service to a mobile subscriber from a neighboring base station comprises the steps of saving a list of operators in the mobile subscriber, detecting signal strengths of a plurality of base stations, and transmitting a request for the limited service to a first base station. The first base station does not belong to any operator in the list and presents a top one signal strength by comparing the signal strengths of all the neighboring base stations.

### FIELD OF THE INVENTION

The invention relates to a method for introducing a limited service to a mobile subscriber from a neighboring base station, and more particularly to the mobile subscriber that is not equipped with a legal subscriber identity module (SIM) card to obtain a specific public land mobile network (PLMN) or a roaming service.

### BACKGROUND OF THE INVENTION

Thanks to recent development in the 2G/3G network, convenience of the personal communication system has made the interpersonal communication more easily and simply, and also leads to the increasing population of the mobile subscribers (also called a mobile station or MS). The consumer (the mobile subscriber) can contact another mobile subscriber without limitation in time and place if and only if they both are in the reachable region of communication signals.

As defined in clause 03.22 of technical specification of European telecom standards institute (ETSI TS), the mobile subscribers employ a limited service state in accordance with the global system for mobile communication (GSM).

A concept of the limited service in GSM relates to that the mobile subscriber can still dial an emergency call such as 911 or 112 though the MS cannot locate a suitable base station of its own home public land mobile network (HPLMN). Generally, if the MS has no SIM card, if the MS cannot locate a suitable base station, or if the MS has no roaming serving, it may still attempt to camp on an acceptable base station so as to obtain the limited service.

In general, when the MS has no SIM card or cannot register (camp on) a base station belong to its own HPLMN, the MS would seek one of neighboring cells (base stations) of other HPLMN for demanding the limited service from the base station. However, in practice, some network operators provide the limited service directly to aliens or may only offer the limited service for the MS without a proper SIM card.

Upon when the MS cannot capture an appropriate limited service for any reason, it is obvious that the user cannot get immediately help from dialing the emergency call while in needs and thus the time of a possible salvage might be delayed.

Unfortunately, the aforesaid problem of the MS using the limited service without inserting the SIM card can not be easily solved by simply utilizing the conventional mobile subscribers alone. So a method for providing the limited service to the mobile subscriber without inserting the SIM card is presented to avoid possible jeopardy in an emergency situation.

### SUMMARY OF THE INVENTION

The object of the present invention is to provide a method for introducing a limited service to a mobile subscriber from a neighboring base station, at the moment when the mobile subscriber does not load a subscriber identity module (SIM) card or is unable to camp on a home public land mobile network (HPLMN).

The mobile subscriber comprises a memory, a receiver, a transmitter, and a microprocessor control unit. The memory is used to save a list of operators, the receiver is used to detect and receive signals of plural neighboring base stations, and the transmitter is used to transmit signals to the base station to link up the base station. The microprocessor control unit processes every broadcast control channel (BCCH) signal of each of the plural base stations so as to have the corresponding signal intensity arranged from strong to small, and then sends the sorted signals out through the transmitter.

In the present invention, the method for introducing a limited service to a MS from a neighboring base station is applied to the situation that the mobile subscriber hasn't loaded an appropriate SIM card, doesn't have a SIM card, or is unable to camp on the HPLMN providing no roaming service. The method comprises the steps of storing a list of operators in the mobile subscriber, detecting signal strength of a plurality signals of neighboring base stations, and transmitting a request for limited service to a first base station that has the most strong (in intensity) signal by compared to signals of other neighboring base stations. In the invention, the candidate base stations may not be one of the operators listed in the list.

### BRIEF DESCRIPTION OF THE DRAWINGS

The features, objects, and advantages of the present invention will become more apparent from the following detailed description of the preferred embodiment of this invention, with reference to the accompanying drawings, in which:

FIG. 1 illustrates schematically a preferred mobile subscriber in a wireless communication system in accordance with the present invention;

FIG. 2 is a flow chart of a preferred method for introducing a limited service to a mobile subscriber from a neighboring base station in accordance with the present invention; and

FIG. 3 shown steps following block B of FIG. 2.

### DETAILED DESCRIPTIONS OF THE PREFERRED EMBODIMENT

For solving the aforesaid problem in using the limited service, a list of operators is preset in a mobile subscriber (also called an MS) so as to identify the operators who provide the limited service. Upon such an arrangement, the mobile subscriber can avoid linking up a base station of an operator that does not support the limited service.

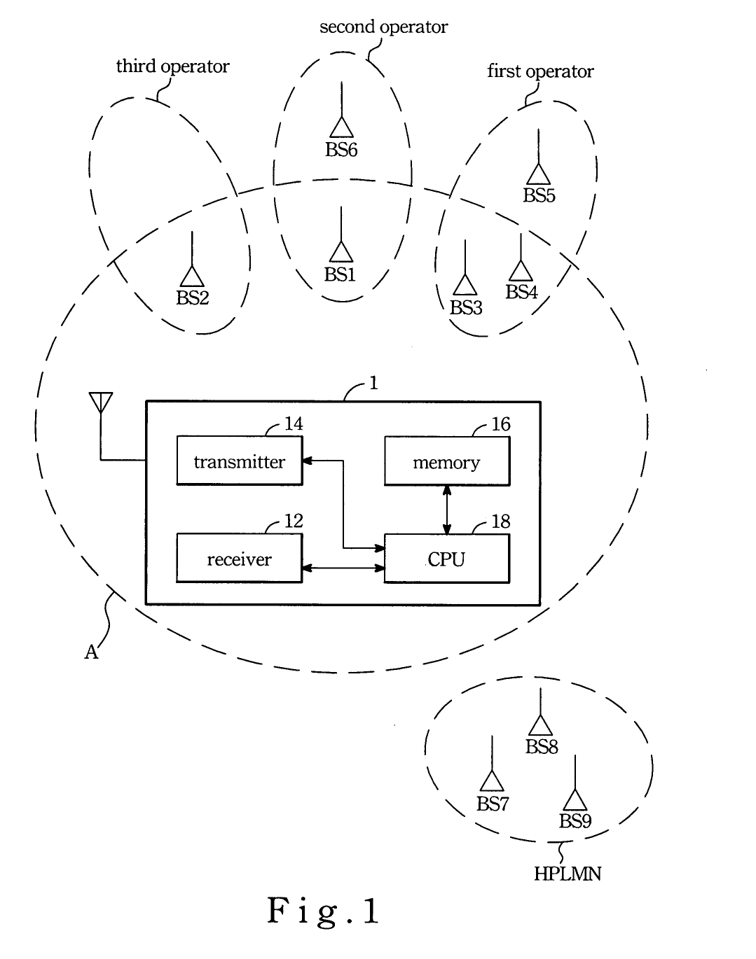

Please refer to FIG. 1 that illustrates schematically a preferred mobile subscriber structure and communication networks in accordance with the present invention. The mobile subscriber 1 located in communication regions of a plurality of base stations comprises a receiver 12, a transmitter 14, a memory 16, and a microprocessor control unit (i.e., a CPU) 18. The receiver 12 is used to detect and receive signals of the plural base stations and then further to output the signals to the microprocessor control unit 18. The microprocessor control unit 18 is coupled to the transmitter 14, the receiver 12, and the memory 16. The transmitter 14 is used to transmit the signals processed by the microprocessor control unit 18 to the plural base stations so as to link up one of the plural base stations. The memory 16 is used to save a list of operators. The microprocessor control unit 18 processes signals received from the receiver 12, compares the source of the signals to the listed operators, and then sends out the comparison results through the transmitter 14. The list of operators established in the mobile subscriber 1 may include mobile country codes (MCC) and mobile network codes (MNC) of the operators that do not offer the limited service.

As shown in FIG. 1, a first operator comprises a plurality of base stations (also called base stations) BS3, BS4, and BS5, a second operator comprises a plurality of base stations BS1 and BS6, a third operator comprises a base station BS2, and a home public land mobile network (HPLMN) operator comprises a plurality of base stations BS7, BS8, and BS9. In FIG. 1, the circle A is used to denote the signal-feasible region of the mobile subscriber 1. The region A covers only base stations BS1, BS2, BS3, and BS4, but not any of the HPLMN. It implies that the mobile subscriber 1 can reach the first operator, the second operator, and the third operator, but not its own HPLMN. It is supposed that, among these three signal-feasible operators, only the first operator can support the limited service. That is to say, the list of operators established in the mobile subscriber 1 includes codes related to the second and the third operators.

For the mobile subscriber 1 is not located in the service region of the HPLMN and does not initiate a roaming service for example, the mobile subscriber 1 can send a request for a limited service to one of the plural base stations BS1, BS2, BS3, and BS4 in the signal-feasible region A. The mobile subscriber 1 sorts the plural neighboring base stations (BS1, BS2, BS3, and BS4) in signal strength and compares with the list of operators. Then, the base stations of operators belonged to the list would be grouped into a lowest primacy list, so that the mobile subscriber 1 can ignore those base stations in advance.

It is supposed that the order of the plural neighboring base stations in signal strength from strong to small is BS1, BS2, BS3, and BS4. For base stations of the second and the third operators are belonged to the lowest primacy list, so the mobile subscriber 1 would ignore the base stations BS1 and BS2 at first and send a request for the limited service to the base station BS3 directly. The mobile subscriber 1 is guaranteed to camp on the base station BS3 of the first operator to use the limited service due to the first operator is already judged in advance to provide the limited service.

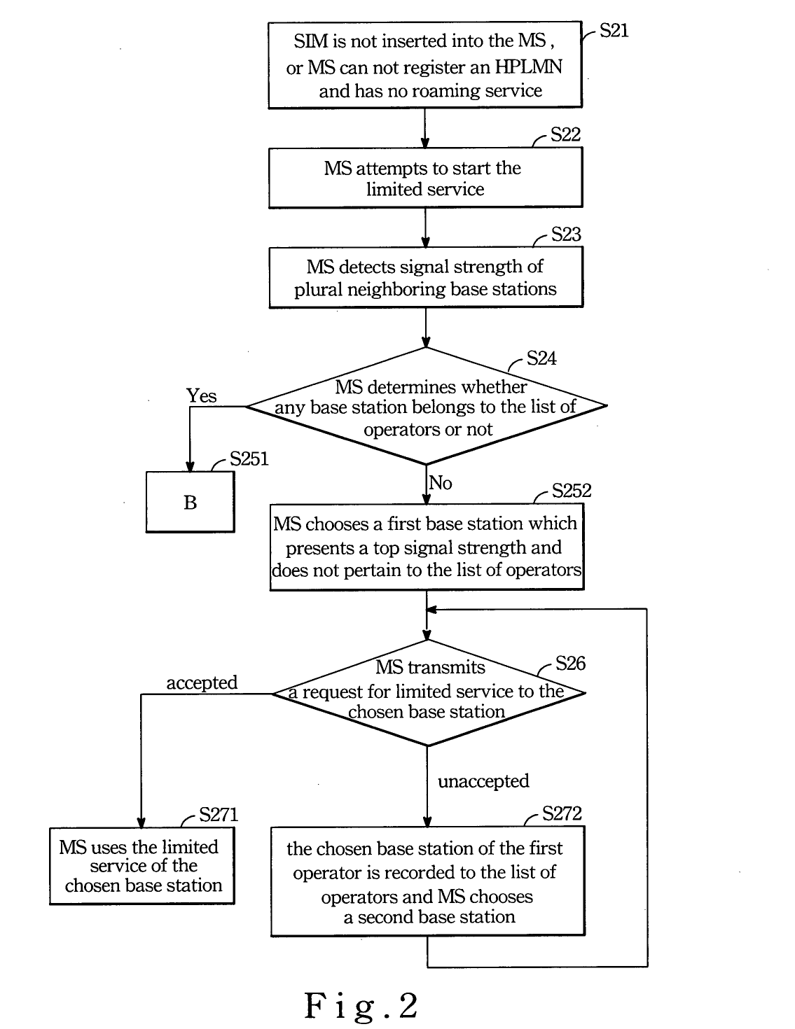

Please refer to FIG. 2, which is a flow chart of a preferred method for introducing a limited service to an MS from a neighboring base station in accordance with the present invention. The list of operators can be established in the memory of the mobile subscriber in advance in the production process, or the mobile subscriber may download the list of operators from the HPLMN while the mobile subscriber links with the HPLMN. The operators in the list do not support the limited service.

In the step S21, a subscriber identity module (SIM) card is not inserted into the mobile subscriber, or the mobile subscriber is unable to camp on an HPLMN or does not initiate any roaming service. In the step S22, the mobile subscriber attempts to start the limited service.

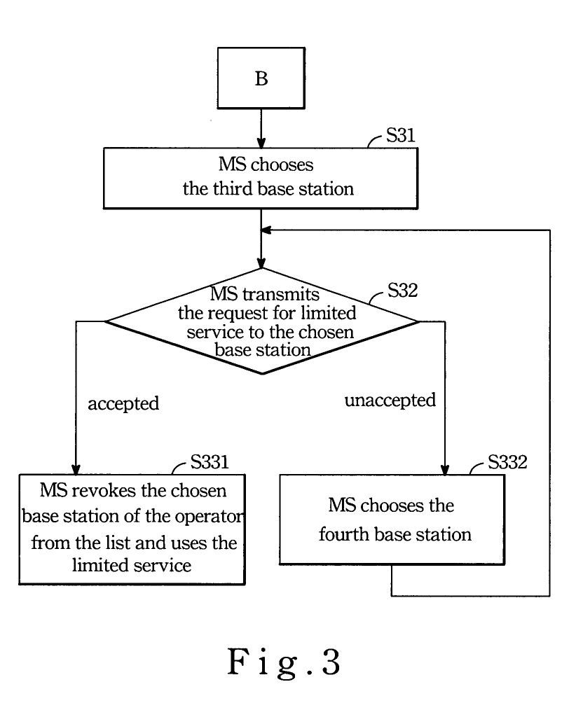

In step 23, the mobile subscriber measures signal strength of plural neighboring base stations, and ranks the measurement results in signal intensity. In the step S24, according to broadcast control channel (BCCH) signals of the base stations, the mobile subscriber judges whether any base station belongs to the list of operators or not. If all the base stations belong to the list of operators, the mobile subscriber carries out a process B at step S251. (Details of the B process would be elucidated in FIG. 3 as follows) Otherwise, if any base station does not belong to the list of operators, the mobile subscriber performs the step S252.

In the step S252, by comparing the list of operators, the mobile subscriber chooses a first base station which has the highest signal strength signal among the other base stations. In the step S26, the mobile subscriber transmits a request for the limited service to the chosen base station (i.e., the first base station). If the chosen base station of the operator provides the limited service and can accept the request, the mobile subscriber would carry out the limited service at step S271. Otherwise, if the chosen base station of the operator does not provide the limited service or an emergency call, the mobile subscriber performs the step S272. The mobile subscriber adds the operator for the first base station to the list of operators. Then, the mobile subscriber chooses a second base station which presents a second top signal strength and may not pertain to the list of operators, and repeat the step S26.

In the above mentioned embodiment, the mobile subscriber is built with the list of operators, and so the mobile subscriber can quickly classify the base stations of the operators in the list to the lowest primacy list. Upon such an arrangement, it can be avoided that the mobile subscriber camps on one base station providing no limited service at all. Thus, by applying the present method, the users can quickly connect to an emergency help while in danger.

Please refer to FIG. 3, which shows processes after block B of FIG. 2. In the above mentioned embodiment as shown as FIG. 2, it may happen that all the neighboring base stations belong to the respective operators in the list of the mobile subscriber, or all the signal-feasible base stations of operators do not support the limited service. Then, the mobile subscriber performs the processes after block B directly to make sure that the mobile subscriber can still have a chance to dial the emergency call or to use the limited service by any way.

In the step S31, the mobile subscriber choose a third base station presenting a third top signal strength according to the measurement results. In the step S32, the mobile subscriber transmits the request for limited service to the chosen base station (the third base station). If the chosen base station of the operator provides the limited service and accepts the request, the mobile subscriber carries out the limited service at step S331. The mobile subscriber revokes the chosen base station of the operator (the third base station of the third operator) from the list of operators and uses the limited service. Otherwise, if the chosen base station of the operator does not provide the limited service or the emergency call, the mobile subscriber performs the step S332. Then, the mobile subscriber chooses a fourth base station which presents the fourth top signal strength, and repeats the step S32.

In any above mentioned embodiment, the limited service can comprise at least two kinds of services, the emergency call and the emergency message. The list of operators can be downloaded and updated from the home public land mobile network while the mobile subscriber links the home public land mobile network. Also the list of operators can be maintained by increasing or revoking operators while the mobile subscriber is performing the register process of the limited service. By providing the present invention, the mobile subscriber would shorten the seeking time in locating a feasible operator that provides the limited service, and thus a better chance for urgent help can be possible to the user of the mobile subscriber, even in a place out of service of its own HPLMN or in a situation of SIM card failure.

Although the present invention and its advantages have been described in detail, as well as some variations over the disclosed embodiments, it should be understood that various other switches, substitutions and alterations can be made herein without departing from the spirit and scope of the invention as defined by the appended claims.

What is claimed is:

1. A method for providing a limited service to a mobile subscriber, comprising:
(a) storing a list of operators in said mobile subscriber;
(b) detecting signal strengths of a plurality signals of neighboring base stations; and
(c) transmitting a request for a limited service to a first base station, said first base station having the highest signal strength signal among base stations which not belonging to any operator in the list of operators.

2. The method according to claim 1, wherein said mobile subscriber is at a state of a group of:
said mobile subscriber having no subscriber identity module (SIM) card;
said mobile subscriber unable to camp on a home public land mobile network (HPLMN); and
said mobile subscriber having no roaming service.

3. The method according to claim 1, wherein, in the step (c), said first base station belongs to a first operator that does not support the limited service, the method further comprising:
adding said first operator to the list of operators.

4. The method according to claim 3, further comprising:
transmitting a new request for the limited service to a second base station, said second base station having the highest signal strength signal among the base stations not belonging to any said operators listed in the list of operators.

5. The method according to claim 1, wherein, in the step (b), all the base stations belong to the operators in the list, the mobile subscriber transmits the request for the limited service to the base stations according to an order of the signal strengths of the signals of the base stations.

6. The method according to claim 5, further comprising:
revoking a third operator of the operators from the list, which a third base station of the third operator supports the limited service to said mobile subscriber.

7. The method according to claim 1, wherein the limited service includes dialing of an emergency service.

8. The method according to claim 1, wherein the limited service includes transmitting of an emergency message.

9. The method according to claim 1, wherein when the mobile subscriber links the home public land mobile network and updates the list of operators from the home public land mobile network.

10. The method according to claim 1, further comprising a step before the step (c), in which said mobile subscriber reads broadcast control channel (BCCH) signals of all the base stations, judges if any of the base stations belongs to the operators in the list, and chooses said first base station that does not belong to the operators in the list.

11. A mobile subscriber comprising:
a memory for storing a list of operators;
a receiver for receiving a plurality signals of neighboring base stations and detecting signal strengths of the signals; and
a transmitter for transmitting a request for a limited service to a first base station, wherein said first base station having the highest signal strength signal among the base stations which not belonging to any said operator in the list.

12. The mobile subscriber according to claim 11, wherein said mobile subscriber links a home public land mobile network and updates the list of operators from the home public land mobile network.

13. The mobile subscriber according to claim 11, further comprising a microprocessor control unit, coupled to said memory and said receiver, reading broadcast control channel (BCCH) signals of the base stations, judging if any of the base stations belongs to the operators in the list, choosing said first base station not belonging to the list of operators.

14. The mobile subscriber according to claim 11, wherein said mobile subscriber is located in the communication region of the plural base stations.
